(19) United States
(12) Patent Application Publication
(10) Pub. No.: US 2002/0081899 A1
(43) Pub. Date: Jun. 27, 2002

(54) Glass-metal leadthrough

(75) Inventor: Walter Korber, Moosburg (DE)

Correspondence Address: CHARLES N.J. RUGGIERO, ESQ., OHLANDT, GREELEY, RUGGIERO & PERLE, L.L.P., ONE LANDMARK SQUARE, 10th FLOOR, STAMFORD, CT, 06901-2682, US

(73) Assignee: Schott Glas

(21) Appl. No.: 09/990,199

(22) Filed: Nov. 21, 2001

Related U.S. Application Data
(63) Continuation-in-part of application No. 09/593,562, filed on Jun. 14, 2000.

(30) Foreign Application Priority Data
Jun. 15, 1999 (DE) 199 27 233.6-34

(51) Int. Cl. H02B 1/01

(52) U.S. Cl. 439/566

(57) ABSTRACT

A glass-metal leadthrough that is useful, for example, for an ignition device of an airbag. The glass-metal leadthrough has two parallel metal pins sealed in a glass stopper on a part of their length, so that they project outwardly from both sides of the stopper beyond its front sides. A cover piece is disposed on one of the front sides and provides a metal contact between one of the pins and a metal sleeve that surrounds the glass stopper.

### RELATED APPLICATION

This application is a continuation-in-part of U.S. patent application Ser. No. 09/593,562, filed on Jun. 14, 2000 for Glass-Metal Leadthrough.

### FIELD OF THE INVENTION

The invention concerns a glass-metal leadthrough. This term is understood to mean vacuum-tight sealings of glasses in metals. The metals are electrical conductors.

### DESCRIPTION OF RELATED ART

Such leadthroughs are widely used in electronics and in electrical engineering. The glass used for sealing thus serves as an insulator. Typical glass-metal leadthroughs are constructed as follows: metal inner conductors are sealed in a pre-shaped sintered-glass part, wherein the sintered glass part is sealed in an outer metal part.

Preferred applications of such glass-metal leadthroughs are, for example, ignition devices. Such ignition devices are used for airbags or for seat belts in motor vehicles. In this case, the glass-metal leadthroughs are a component of an ignition device. The entire ignition device comprises, in addition to the glass-metal leadthrough, an ignition bridge, the explosive substance, and a metal cover, which tightly surrounds the ignition mechanism. The leadthrough thus plays an important role. It is necessary in order to reliably introduce to a housing, in an insulated manner, the electrical voltage that is produced by one or two metal pins.

Known glass-metal leadthroughs are constructed as follows: a glazed pin is used as a ground wire by means of conductive epoxy resin or by means of an electrically conductive adhesive. The pin thus produces the necessary connection to the metal housing. This form of embodiment is very complex and expensive in its manufacture. A more serious disadvantage is comprised of the fact that the ground contact is not reliably adjusted relative to the external housing. This can have serious consequences, particularly in the case of the named application examples of airbag or seat belt.

The object of the invention is to create a glass-metal leadthrough, which assures a reliable ground contact to the external metal part and in fact assures this for a long time after it is incorporated. The manufacture of the leadthrough in a cost-favorable manner will also be possible.

### SUMMARY OF THE INVENTION

A solder-coated cover piece is provided, which is arranged on one of the two front sides of the glass stopper and surrounds one of the two metal pins in a conductive manner. Such a solder-coated cover piece is introduced in the fusion mold when the parts are assembled. A secure ground contact to the external metal part is assured by introducing the cover piece. The cover piece should be introduced during the glazing process.

The glass-metal leadthrough according to the invention perfectly fulfills its functions. However, it is also cost-favorable. Geometrically more complicated and thus more expensive metal parts are superfluous. Post-processing is no longer necessary, not even a post-processing by the customer, who incorporates the glass-metal unit in a corresponding device, for example, in an ignition device.

### BRIEF DESCRIPTION OF THE DRAWING

The invention is explained in more detail on the basis of the drawing. Here, the following is shown individually:

FIG. 1 shows in a perspective view a so-called ignition cap, for example, as is used for an airbag.

FIG. 2 shows a glass-metal leadthrough according to the invention, which is a component of the ignition cap according to FIG. 1.

FIG. 3 illustrates a glass-metal leadthrough according to the prior art.

FIG. 4 illustrates another glass-metal leadthrough according to the prior art.

### DESCRIPTION OF THE INVENTION

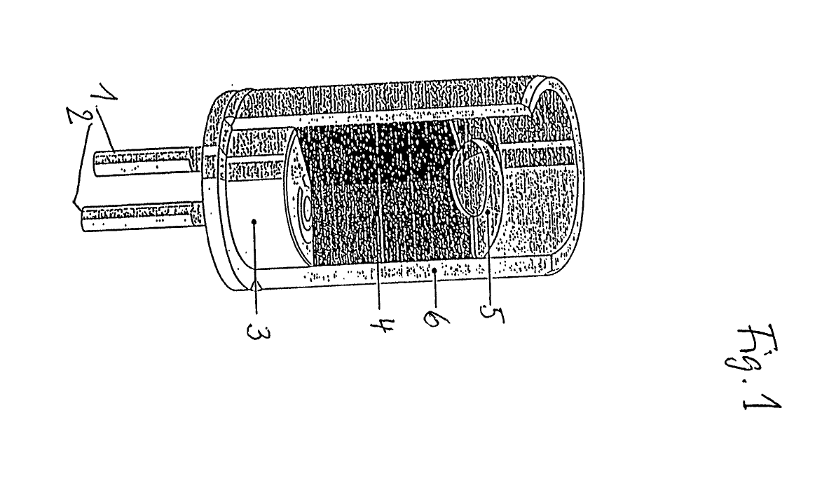

The ignition cap shown in FIG. 1 comprises two metal pins 1, 2 which serve as plug connectors, a glass leadthrough 3, an ignition assembly 4, a cover 5 as well as a sleeve 6. The cover is made by stamping a metallic blank and the sleeve is made by cutting a metallic tube.

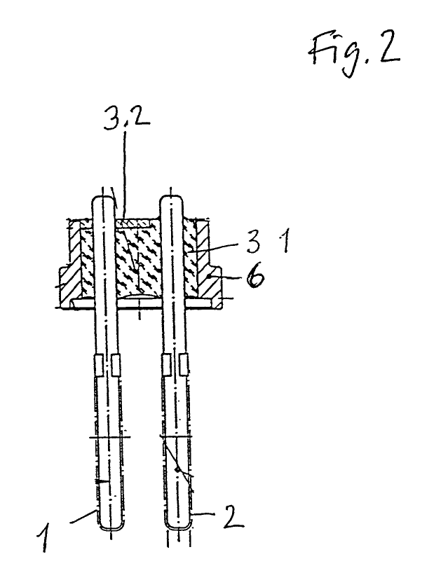

In the glass-metal leadthrough of the invention according to FIG. 2, one again recognizes two metal pins 1, 2. These are sealed in a glass stopper 3.1. On the two front sides of glass stopper 3.1, they project beyond this stopper and project to a further distance on the lower side than on the upper side. The two metal pins 1, 2 form the plug connector.

The glass stopper is surrounded by a metal sleeve 6. A solder coated cover piece 3.2 is recognized as the most important element also according to the invention. The solder coated cover piece 3.2 is sealed in glass stopper 3.1 together with the two metal pins 1 and 2 and provides a conducting connection between metal pin 1 and sleeve 6. In contrast, there is no conductive connection with pin 2

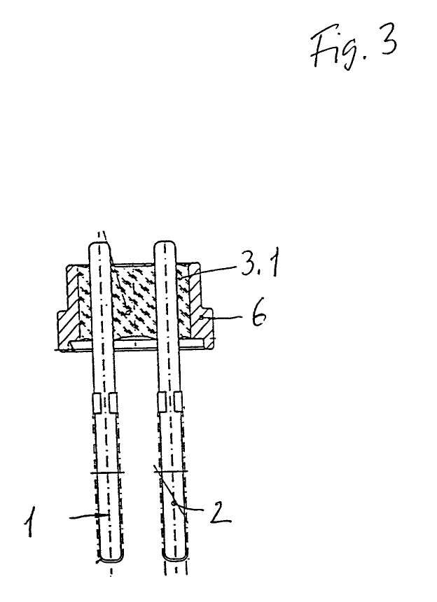

In the form of embodiment according to FIG. 3, which belongs to the prior art, one again recognizes the two metal pins 1, 2, the glass stopper 3.1 as well as sleeve 6. However, a cover piece 3.2 is missing here.

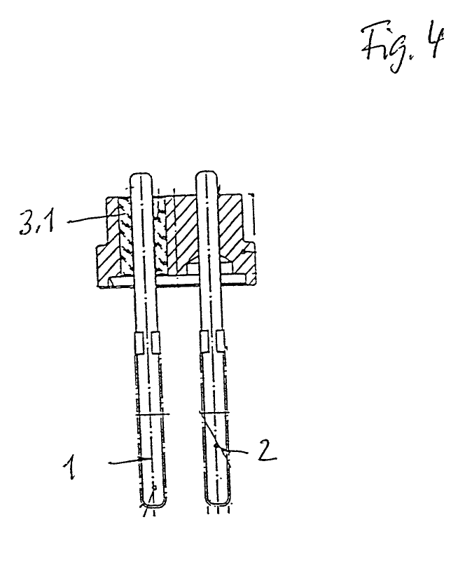

This is also the case in the previously known form of embodiment according to FIG. 4. A cover piece is also missing here. Only metal pin I is sealed in a glass stopper 3.1

1. A glass-metal leadthrough comprising:
two metal pins disposed parallel to one other;
a glass stopper having first and second sides, wherein said two metal pins are sealed in said glass stopper so as to project out from said first and second sides of said glass stopper;
a metal sleeve, prepared by cutting a metallic tube, surrounding said glass stopper; and
a cover piece, prepared by stamping, arranged on said first side of said glass stopper so as to surround one of said two pins in a conductive manner, said cover piece being connected in a conductive manner with said metal sleeve.

2. The glass-metal-leadthrough according to claim 1, wherein said cover piece is flush with said first side of said glass stopper.
